(19) United States
(12) Patent Application Publication
(10) Pub. No.: US 2007/0274673 A1
(43) Pub. Date: Nov. 29, 2007

(54) Digital video recording device having detachable user interface

(75) Inventor: Yu-Cheng Huang, Hsinchu County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Altek Corporation, Hsinchu (TW)

(21) Appl. No.: 11/440,283

(22) Filed: May 24, 2006

(51) Int. Cl. H04N 5/91

(52) U.S. Cl. 386/46

(57) ABSTRACT

A digital video recording device including a body and a user interface detachably disposed on the body is provided. When the body is combined with the user interface, control members on the user interface use a connection interface to control the video recording function of a video recording module on the body, and when the body is detached from the user interface, the control members wirelessly control the video recording function. Thus the user interface on the body can be detached from the body to serve as a remote controller, such that the problems that the device is inconvenient to carry or the size of the device becomes larger due to an additional remote controller are avoided, while providing the function of remote control.

### BACKGROUND OF THE INVENTION

1. Field of Invention

The present invention relates to a video recording device. More particularly, the present invention relates to a digital video recording device, which has a detachable user interface, wherein when the body is combined with the user interface, the video recording module can be controlled in a wired mode, and when the body is detached from the user interface, the video recording module can be controlled in a wireless mode.

2. Related Art

With the development of multimedia technology, digital video recording devices, for example, digital cameras and digital video cameras have become quite popular as they have display screens that enable users to view the images or videos in advance.

The preview function of digital cameras enables users to filter images shot to prevent them from being seen by others, thus self-photographing has become more and more frequent. Presently, digital cameras are controlled by users through direct manipulation, including the setting of shooting parameters and the setting of shutter time, on the bodies of the cameras in most cases. When users leave the camera bodies, though shooting can be controlled in a timed or remote control manner, the users have to adjust all shooting parameters, such as the setting of focal length, the setting of aperture, and the setting of distance, on the camera bodies in advance for both control modes. In other words, when the users leave the camera bodies, the shooting parameters can no longer be adjusted. Therefore, in case of self-photographing, the shooting has to be performed by means of timed control or remote control as described above. Taking the remote control mode as an example, the shooting position or an object at the shooting position has to be found first, and the user must move to the shooting position after the focal length is adjusted, and then press the remote controller to shoot a picture. As the remote controller of the conventional digital camera can only control the shutter of the camera, it is difficult to shoot successful pictures with the method described above in actual use.

Moreover, digital cameras are often used during travels. However, as the remote controllers are normally the devices additionally disposed, additional remote controllers have to carried, which is inconvenient for users, and easy to be lost.

In addition, a digital camera structure design is developed, which sets an accommodation slot in the body of the digital camera to accommodate the remote controller when it is not used. However, an extra space has to be added on the body of the digital camera to set the accommodation slot, such that the size of the digital camera body cannot be minimized, which is against the development trend of becoming light in weight and compact in size.

### SUMMARY OF THE INVENTION

Accordingly, an object of the present invention is to provide a digital video recording device, such that the problems of inconvenient self-photographing, inconvenience in carrying remote controllers and/or limitations on the sizes of digital video recording devices described in the prior art can be solved.

Therefore, in order to achieve the object, a digital video recording device is disclosed in the present invention, which comprises a body and a user interface, wherein the user interface may be detachably disposed on the body.

The body includes a video recording module for capturing an image, and a display connected to the video recording module for displaying the captured image. The user interface includes one or more control members for correspondingly controlling one or more video recording functions of the video recording module. When the body is combined with the user interface, the control member controls the video recording by the use of a connection interface. When the body is detached from the user interface, the control member wirelessly controls the video recording.

Thus the user interface on the body can be detached from the body to serve as a remote controller, such that the problems that the device is inconvenient to carry or the size of the device becomes larger due to an additional remote controller are avoided, while providing the function of remote control.

The user interface further includes a display screen to display the control state of the shooting function corresponding to the control member.

Furthermore, a first wireless transceiver and a second wireless transceiver can be respectively disposed in the body and the user interface, such that the control member can control the video recording function of the video recording module through the wireless connection between the first and the second wireless transceivers.

Moreover, a first connector and a second connector corresponding to each other can be respectively disposed in the body and the user interface (i.e., forming the aforementioned connection interface), such that the control member is electrically connected to the video recording module via the first and the second connectors. When the first connector is connected to the second connector, the control member is electrically connected to the video recording module via the first and the second connectors to control the corresponding video recording function, and when the first connector is separated from the second connector, the control member is wirelessly connected to the video recording module via the first and the second wireless transceivers to control the corresponding video recording function.

The user interface further includes a second power module for storing power and providing it to the user interface, so as to maintain the operation of the user interface. Besides, one or more switches can be disposed on the user interface to switch the signal paths and/or power supply on the user interface.

As for features and examples of the present invention, preferred embodiments will be illustrated in detail with reference to the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1A is a schematic block diagram of the digital video recording device according to a first embodiment of the present invention;

FIG. 1B is a schematic block diagram of the digital video recording device according to a second first embodiment of the present invention;

FIG. 2A is an appearance view of the digital video recording device according to the first embodiment of the present invention;

FIG. 2B is an appearance view of the digital video recording device according to the second embodiment of the present invention;

FIG. 3 is an appearance view of the digital video recording device according to a third embodiment of the present invention;

FIG. 4A is a schematic block diagram of the digital video recording device according to a fourth embodiment of the present invention;

FIG. 4B is an appearance view of the digital video recording device according to the fourth embodiment of the present invention;

FIG. 5 is a schematic block diagram of the digital video recording device according to a fifth embodiment of the present invention;

FIG. 6 is a schematic block diagram of the digital video recording device according to a sixth embodiment of the present invention;

FIG. 7 is a schematic block diagram of the digital video recording device according to a seventh embodiment of the present invention;

FIG. 8 is a schematic block diagram of the digital video recording device according to an eighth embodiment of the present invention;

FIG. 9 is a schematic block diagram of the digital video recording device according to a ninth embodiment of the present invention;

FIG. 10 is a schematic block diagram of the digital video recording device according to a tenth embodiment of the present invention;

FIG. 11A is a schematic block diagram of the digital video recording device according to an eleventh embodiment of the present invention; and

FIG. 11B is a schematic block diagram of the digital video recording device according to a twelfth embodiment of the present invention.

### DETAILED DESCRIPTION OF THE INVENTION

The content of the present invention is illustrated in detail through specific embodiments accompanied with the drawings. Symbols mentioned in the specification are symbols in the reference drawings.

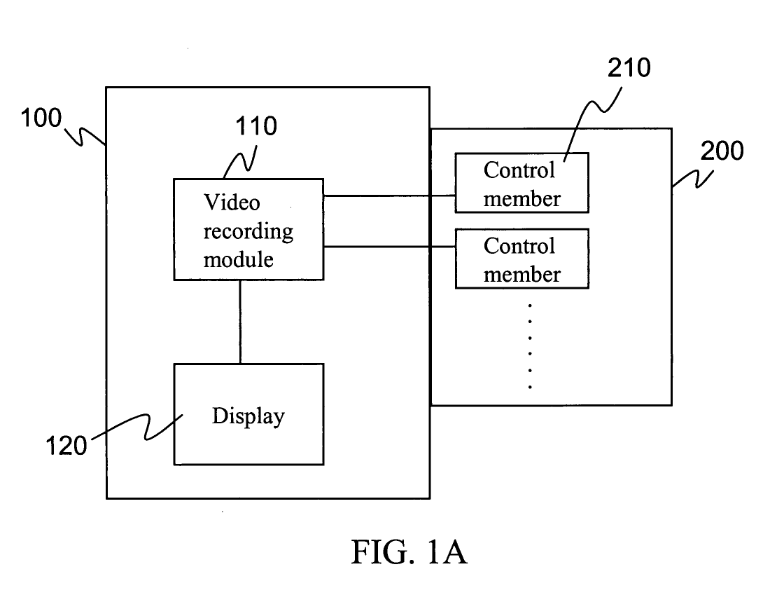

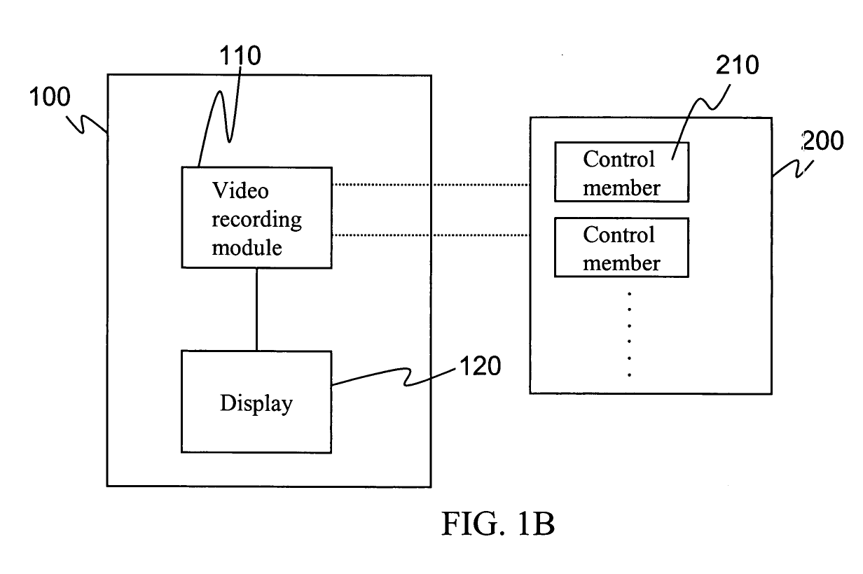

FIGS. 1A and 1B show a digital video recording device according to the present invention, which comprises a body 100 and a user interface 200.

A video recording module 110 is disposed on the body 100 to capture an image. In other words, the video recording module may include image capturing elements, such as lens, that are essential to the common conventional digital image shooting devices, such as digital cameras and digital video cameras. Moreover, a display 120 is also disposed on the body 100, and is electrically connected to the video recording module 110, so as to display the images captured by the video recording module 110 for the users' reference.

The user interface 200 may be detachably disposed on the body 100, and has one or more control members 210 for controlling the video recording module 110 on the body 100. In other words, the user can control various video recording functions of the digital video recording device with the control member 210 on the user interface 200, such as focal length adjustment, photometering, exposure value setting, photosensitivity setting, flash setting and shutter control. That is, the control members 210 may include the shutter key and other functional keys to correspondingly control the video recording functions of the video recording module 110 respectively.

When the body 100 is combined with the user interface 200, the control member 210 controls the video recording functions of the video recording module 110 by the use of a connection interface, as shown in FIG. 1A. When the body 100 is separated from the user interface 200, the control member wirelessly controls the video recording functions of the video recording module 110, as shown in FIG. 1B.

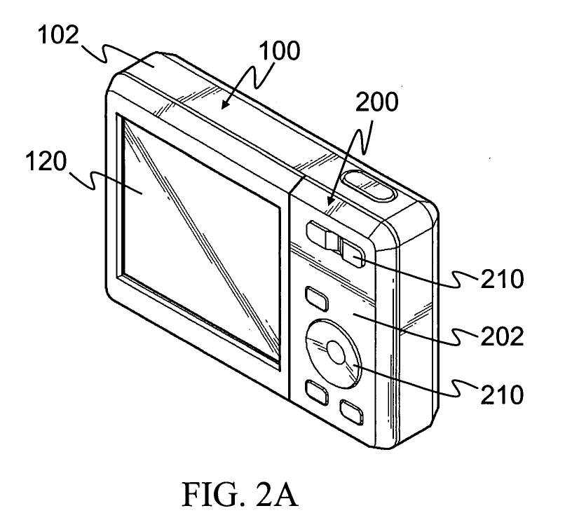

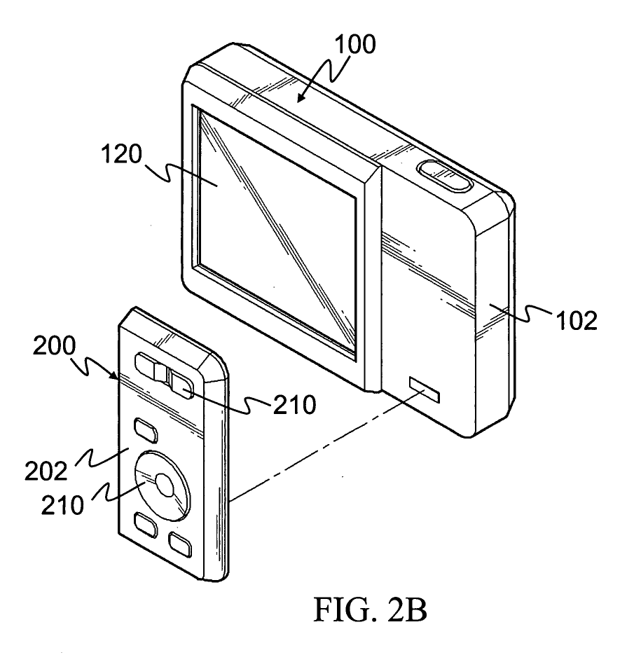

For example, as shown in FIGS. 2A and 2B, the body 100 has a first shell 102, on which the video recording module (not shown) and the display 120 are disposed. The user interface 200 has a second shell 202, on which the control member 210 is disposed. The second shell 202 may be detachably disposed on the first shell 102, therefore, the body 100 and the user interface 200 can be combined or separated in use as required, such that the body 100 is remotely controlled with the user interface 200.

It is not necessary to dispose the video recording module on the body. In both cases that the user interface is disposed on the body or the user interface is separated from the body, the digital video recording device can be controlled with the control member on the user interface.

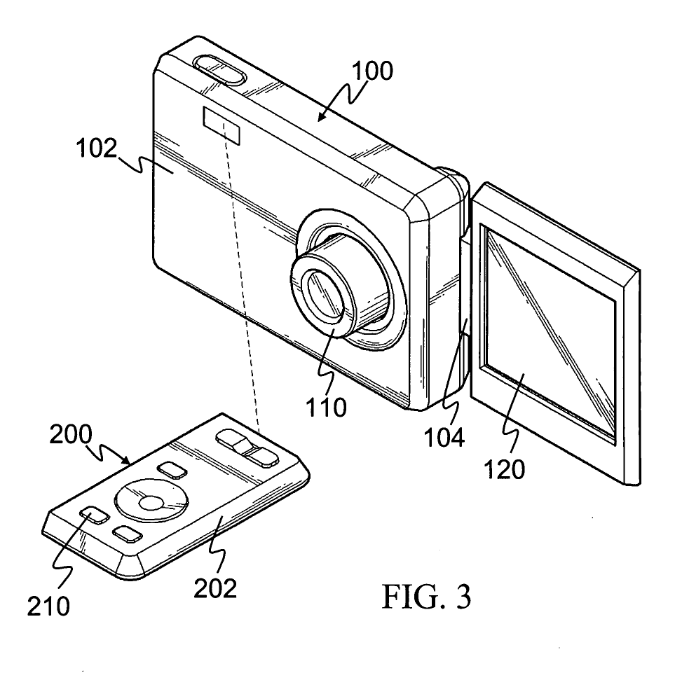

In addition, as shown in FIG. 3, the display 120 on the body 100 adopts a pivoted design, that is, the display 120 can be disposed on the first shell 102 with a shaft 104. When the body 100 is combined with the user interface 200, the display 120 can be accommodated on the back of the first shell 102, i.e., the side opposite to the lens of the video recording module 110. When the body 100 is separated from the user interface 200, the display 120 can be rotated to leave the first shell 102 via the shaft 104, such that the image displayed by the display 120 and the lens of the video recording module 110 face the same side, thus facilitating users' referencing the image of the display 120 when performing the remote control with the user interface 200.

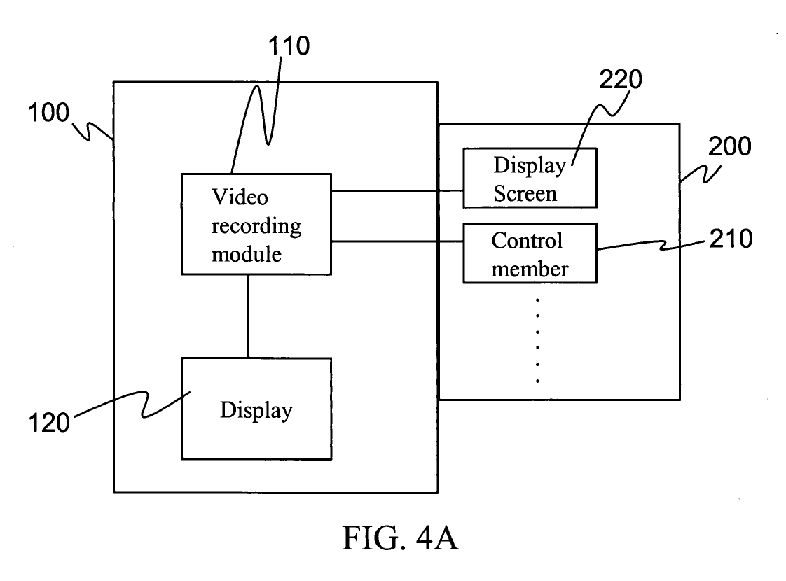

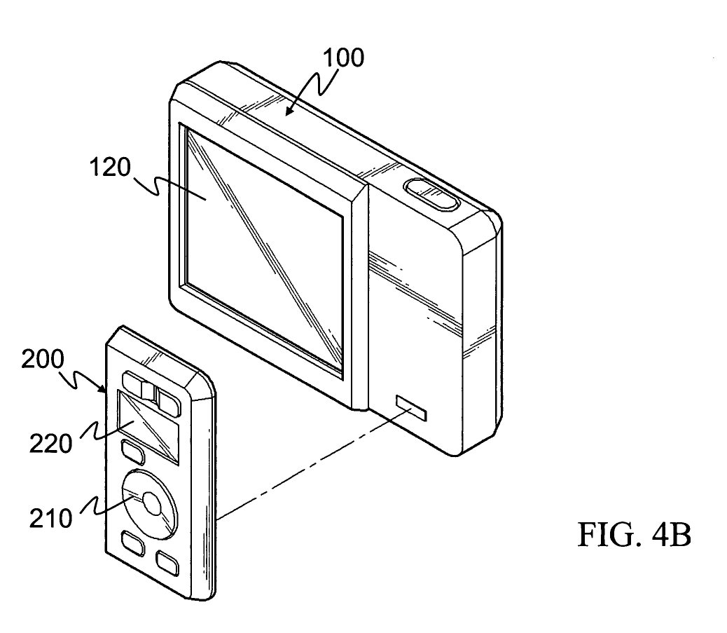

Moreover, as shown in FIGS. 4A and 4B, a display screen 220 can also be disposed on the user interface 200 to display the control state of corresponding video recording function of the control member 210. When the body 100 is combined with the user interface 200, the display screen 220 of the user interface 200 represents an idle state, such as an off state, a standby image or no image. When the body 100 is separated from the user interface 200, the display screen 220 of the user interface 200 shows the control state of the corresponding video recording function of the control member 210, such as the exposure value, the photosensitivity, and whether a flash is being used.

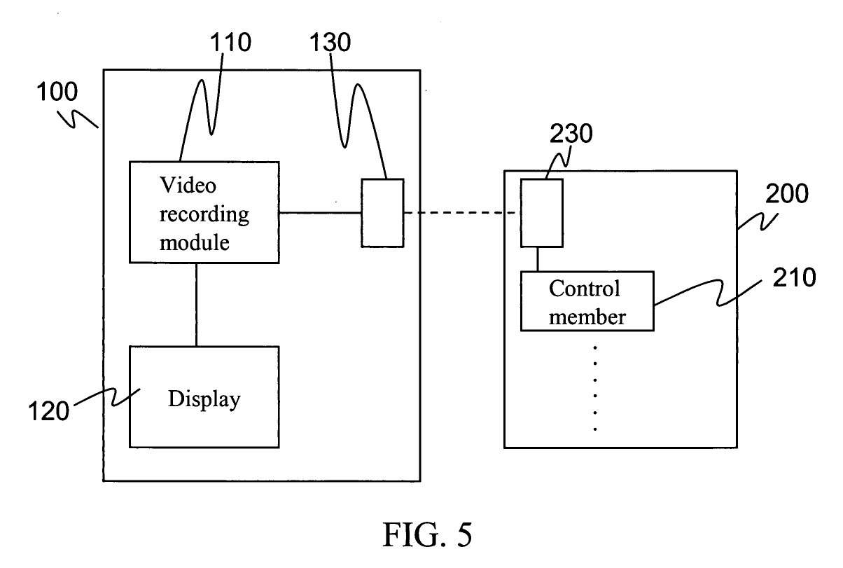

As shown in FIG. 5, a first wireless transceiver 130 and a second wireless transceiver 230 are respectively disposed in the body 100 and the user interface 200. The first wireless transceiver 130 and the second wireless transceiver 230 are corresponding to each other, such that the control member 210 controls the video recording module 110 through the wireless connection between the first wireless transceiver 130 and the second transceiver 230. In other words, the first wireless transceiver 130 is electrically connected to the video recording module 110, and the second wireless transceiver 230 is electrically connected to the control member 210. The control signal of the control member 210 can be wirelessly transmitted by the first wireless transceiver 130 and the second wireless transceiver 230, so as to control the video recording function corresponding to the video recording module 110.

The first and the second wireless transceivers can be radio frequency (RF) transceiving modules, blue tooth transceiving modules, wireless local area network (WLAN) transceiving modules, or wireless transceiving modules or microwave transceiving modules of the same series as 802.11x standard of the Institute of Electrical and Electronics Engineers (IEEE) that are corresponding to each other.

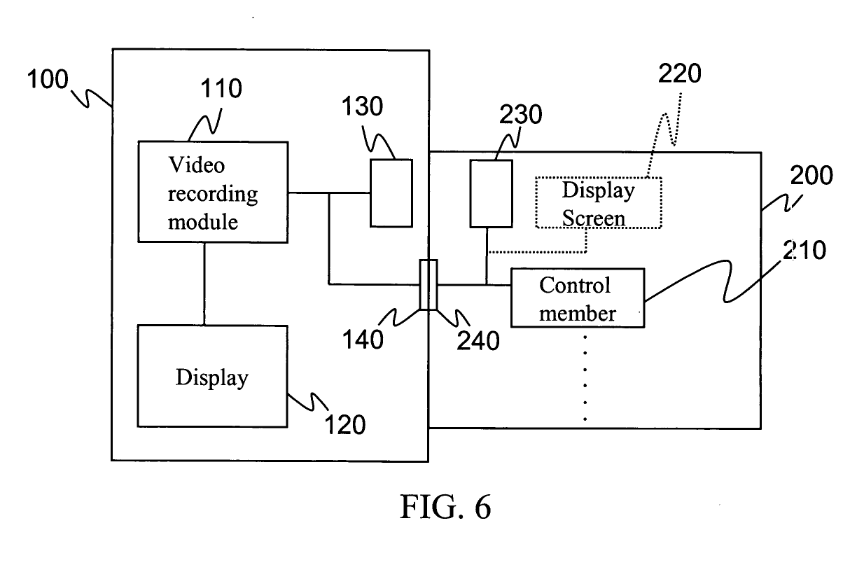

Furthermore, as shown in FIG. 6, a first connector 140 and a second connector 240 can be disposed respectively in the body 100 and the user interface 200. The first connector 140 and the second connector 240 can be corresponding to each other, that is, the first connector 140 and the second connector 240 can be connected, such that the control member 210 is electrically connected to the video recording module 110 via the first connector 140 and the second connector 240, so as to control the video recording function corresponding to the video recording module 110 in a wired mode.

When the first connector 140 is connected to the second connector 240, the control member 210 can be directly electrically connected to the video recording module 110 via the first connector 140 and the second connector 240, so as to control the corresponding video recording function in a wired mode. In addition, when the first connector 140 is separated from the second connector 240, that is, when they are not connected, the control member 210 wirelessly controls the video recording function corresponding to the video recording module 110 via the signal connection between the first wireless transceiver 130 and the second wireless transceiver 230.

The first connector and the second connector may be one or more conductive plates or male/female connectors corresponding to each other.

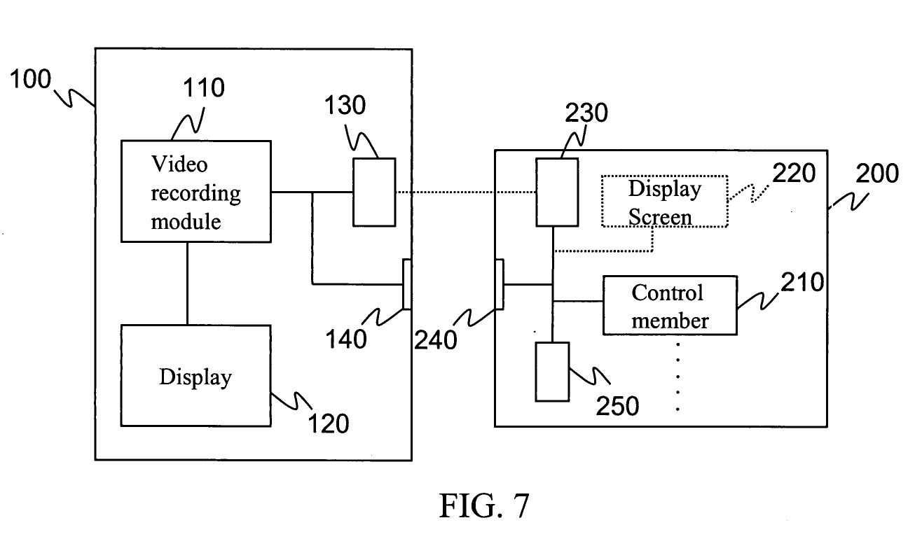

As shown in FIG. 7, a second power module 250 can be disposed on the user interface 200 to store a power, which provides the required power during the operation of the user interface 200. In other words, the second power module 250 can be electrically connected to various components on the user interface 200, for example, the control members 210, the display screen 220, the second wireless transceiver 230 and/or the second connector 240, so as to provide power to the components and maintain their operations.

The power module can be a battery/a battery pack, a battery cell or a solar battery pack, and the like.

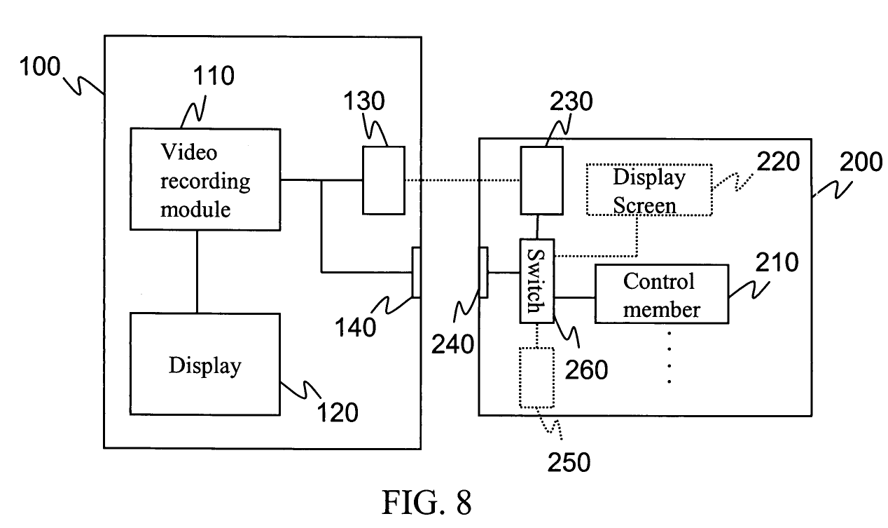

Moreover, as shown in FIG. 8, a switch 260 is further disposed on the user interface 200, which is electrically connected to various components on the user interface 200, for example, the control member 210, the display screen 220, the second wireless transceiver 230, and/or the second connector 240 described above. When the first connector 140 is connected to the second connector 240, the switch 260 electrically connects the control member 210 and the second connector 240, such that the control member 210 is electrically connected to the video recording module 110 via the first connector 140 and the second connector 240. When the first connector 140 is separated from the second connector 240, the switch 260 electrically connects the control member 210 and the second transceiver 230, such that the control member 210 is wirelessly connected to the video recording module 110 via the first wireless transceiver 130 and the second wireless transceiver 230. Furthermore, when the first connector 140 is separated from the second connector 240, the switch 260 may also electrically connect the second power module 250 on the user interface 200 to various components on the user interface 200, for example, the control members 210, the display screen 220, the second wireless transceiver 230 and/or the second connector 240, so as to provide the power required by the components when the user interface 200 performs the wireless control. Moreover, a plurality of switches can be used synchronically to switch the signal path and/or power supply when the first connector 140 and the second connector 240 are connected/separated.

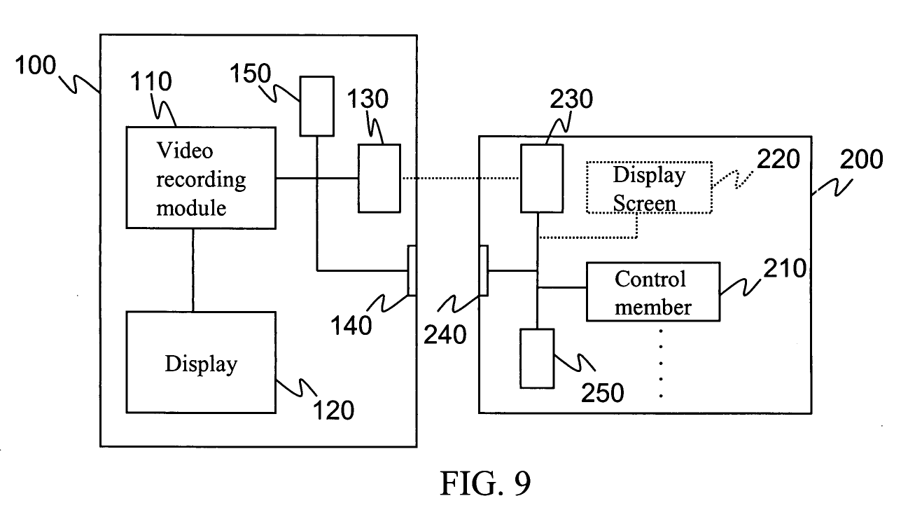

In addition, as shown in FIG. 9, the body 100 also has a first power module 150 to store a power and provides the power required during the operation of the body 100. When the first connector 140 is connected to the second connector 240, the power required by the user interface 200 when operating can be provided by the first power module 150 on the body 100 via the first connector 140 and the second connector 240. When the first connector 140 is separated from the second connector 240, the power required by the user interface 200 is provided by the second power module 250 on it to maintain its operation.

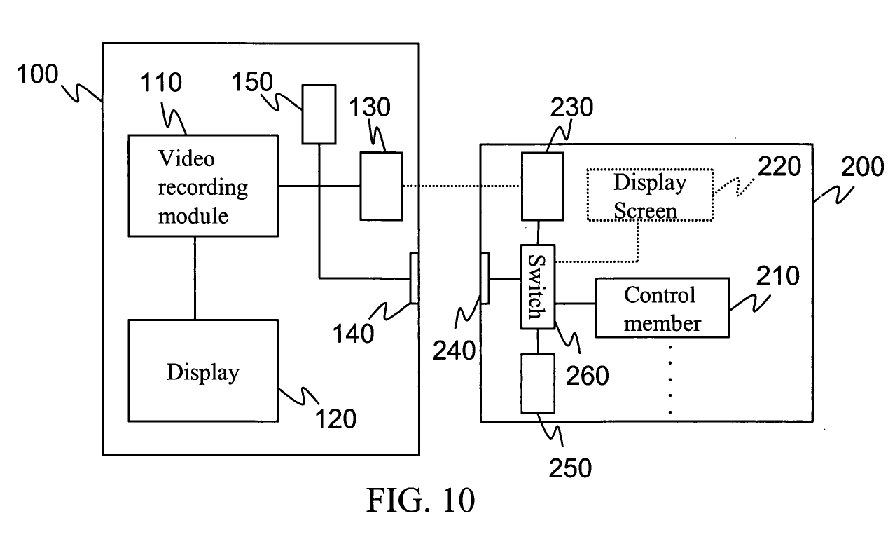

As shown in FIG. 10, one or more switches 260 can be disposed on the user interface 200 to switch the signal paths and/or power supply of the user interface 200. That is, when the first connector 140 is connected to the second connector 240, the switch 260 may electrically connect the control member 210 and the second connector 240, such that the control member 210 is electrically connected to the video recording module 110 via the first connector 140 and the second connector 240. Meanwhile, the power supplied by the first power module 150 on the body 100 is obtained via the first connector 140 and the second connector 240 to maintain the operation of the control members 210. When the first connector 140 is separated from the second connector 240, the switch 260 can electrically connect the control member 210 and the second wireless transceiver 230, such that the control member 210 is wirelessly connected to the video recording module 110 via the first wireless transceiver 130 and the second wireless transceiver 230, and can electrically connect various components on the user interface 200 (e.g., the control members 210, the display screen 220, the second wireless transceiver 230 and/or the second connector 240 described above) to the second power module 250, so as to maintain the operations of the components.

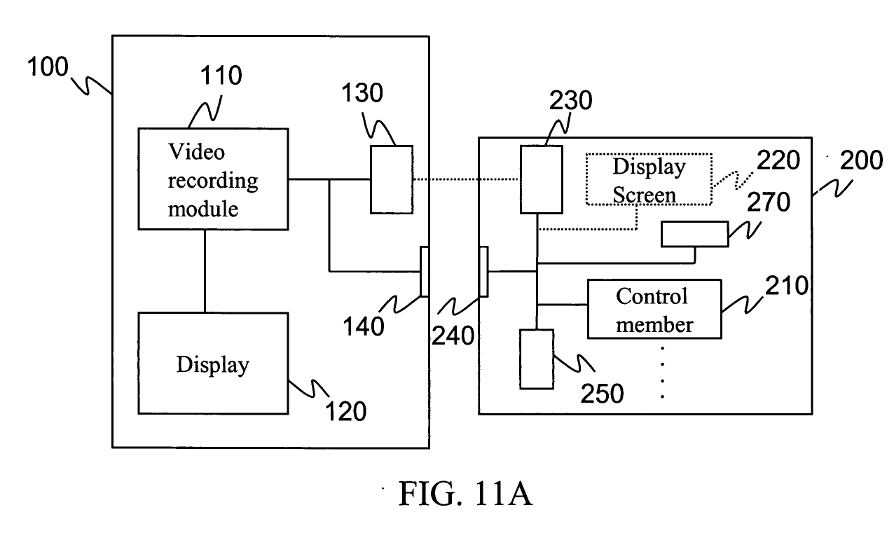

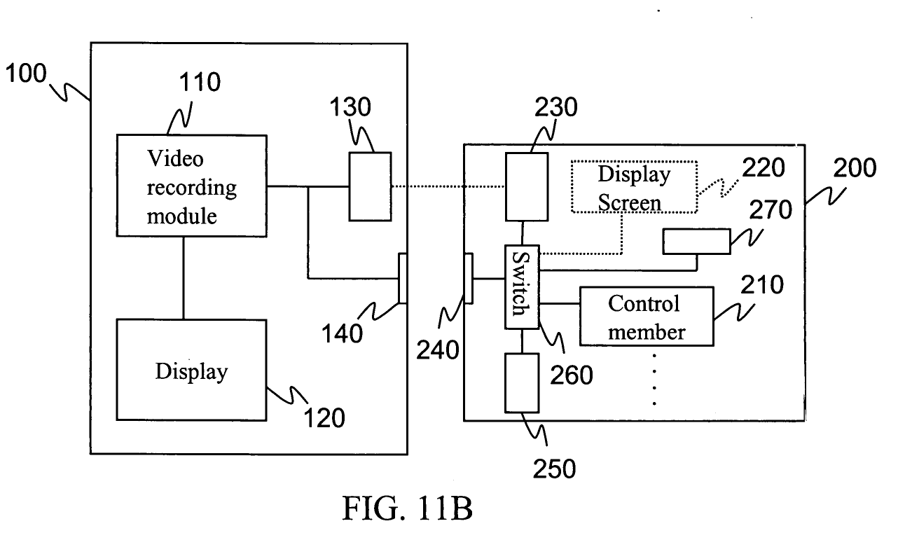

In addition, as shown in FIGS. 11A and 11B, one or more storage units 270 may also be disposed on the user interface 200 (only one storage unit is shown to facilitate the illustration), so as to store the control states of the video recording functions, i.e., the control state of each of the video recording functions of the video recording module 110, such as the exposure value, the photosensitivity, and whether a flash is being used.

When the first connector 140 is connected to the second connector 240, the signal data corresponding to the control state of the video recording function can be transmitted from the body 100 via the first connector 140 and the second connector 240, and stored in the storage units 270. When the first connector 140 is separated from the second connector 240, the signal data are wirelessly transmitted via the wireless connection between the first wireless transceiver 130 and the second wireless transceiver 230, and are stored in the storage unit 270.

Moreover, the body 100 can also wirelessly transmit the signal data corresponding to the control states of the video recording functions via the wireless connection between the first wireless transceiver 130 and the second wireless transceiver 230, and store them in the storage units 270 only when the first connector 140 is separated from the second connector 240. Then the stored signal data can be updated with the operation of the control member 210.

Here, the storage units 270 can be various storage media such as memories.

The present invention not only can provide the remote control function but also can facilitate users' referencing the image of the display when performing the remote control. In addition, the present invention solves the problems that of inconvenient to carry or the size of the device becomes larger due to an additional remote controller. Therefore, a technical advance is also achieved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A digital video recording device, comprising:
a body, including:
a video recording module for capturing an image;
a display, electrically connected to the video recording module for displaying the image;
a first wireless transceiver, electrically connected to the video recording module; and
a user interface, detachably disposed on the body, including:
at least one control member for correspondingly controlling at least one video recording function of the video recording module; and
a second wireless transceiver, corresponding to the first wireless transceiver, and electrically connected to the control member; wherein the control member controls the video recording function of the video recording module through the wireless connection between the first wireless transceiver and the second wireless transceiver.

2. The digital video recording device as claimed in claim 1, wherein the user interface further comprises:
a display screen, for displaying a control state of the video recording function corresponding to the control member.

3. The digital video recording device as claimed in claim 2, wherein when the body is combined with the user interface, the display screen of the user interface represents an idle state; and when the body is separated from the user interface, the display screen of the user interface is used to display the control state of the video recording function corresponding to the control member.

4. The digital video recording device as claimed in claim 1, wherein the body further comprises:
a first shell, for disposing the video recording module, the display, and the first wireless transceiver; and
wherein the user interface further comprises:
a second shell, detachably disposed on the first shell, for disposing the control member and the second wireless transceiver.

5. The digital video recording device as claimed in claim 1, wherein the user interface further comprises:
a second power module, electrically connected to the control member and the second wireless transceiver, for storing a power; wherein the power is used to maintain the operations of the control member and the second wireless transceiver.

6. The digital video recording device as claimed in claim 1, wherein the body further comprises:
a first connector, electrically connected to the video recording module; and wherein the user interface further comprises:
a second connector corresponding to the first connector, wherein when the first connector is connected to the second connector, the control member is electrically connected to the video recording module via the first connector and the second connector to control the corresponding video recording function; and when the first connector is separated from the second connector, the control member is wirelessly connected to the video recording module via the first wireless transceiver and the second wireless transceiver to control the corresponding video recording function.

7. The digital video recording device as claimed in claim 6, wherein the user interface further comprises:
a second power module, electrically connected to the control member and the second wireless transceiver, for storing a power, wherein the power is used to maintain the operations of the control member and the second wireless transceiver.

8. The digital video recording device as claimed in claim 6, wherein the user interface further comprises:
at least one switch, electrically connected to the control member, the second connector, and the second wireless transceiver, wherein when the first connector is connected to the second connector, the switch is used to electrically connect the control member and the second connector; and when the first connector is separated from the second connector, the switch is used to electrically connect the control member and the second wireless transceiver.

9. The digital video recording device as claimed in claim 6, wherein the body further comprises:
a first power module, electrically connected to the video recording module, the display, the first connector and the first wireless transceiver, for storing a power; and wherein the user interface further comprises:
a second power module, electrically connected to the control member and the second wireless transceiver, for storing a power, wherein when the first connector is connected to the second connector, the power required by the user interface is provided by the first power module on the body via the first connector and the second connector; and when the first connector is separated from the second connector, the power required by the user interface is provided by the second power module on the user interface.

10. The digital video recording device as claimed in claim 9, wherein the user interface further comprises:
at least one switch, electrically connected to the control member, the second power module, the second connector and the second wireless transceiver, wherein when the first connector is connected to the second connector, the switch is used to electrically connect the control member and the second connector; and when the first connector is separated from the second connector, the switch is used to electrically connect the control member and the second wireless transceiver and to electrically connect the control member and the second power module.

11. The digital video recording device as claimed in claim 1, wherein the user interface further comprises:
at least one storage unit, for storing the control state of the video recording function.

12. The digital video recording device as claimed in claim 11, wherein when the body is combined with the user interface, the storage unit obtains the control state of the video recording function of the video recording module in a wired mode and stores the control state; and when the body is separated from the user interface, the storage unit obtains the control state of the video recording function of the video recording module in a wireless manner and stores the control state.

13. The digital video recording device as claimed in claim 1, wherein the body further comprises:
a shell, for disposing the video recording module; and
a shaft, for rotatably disposing the display on the shell.
